(19) United States
(12) Patent Application Publication
(10) Pub. No.: US 2019/0311359 A1
(43) Pub. Date: Oct. 10, 2019

(54) Method for Tokenization of Financial Contracts on Decentralized Computing Networks

(71) Applicant: Nicholas Fett, Frederick, MD (US)

(72) Inventor: Nicholas Fett, Frederick, MD (US)

(21) Appl. No.: 15/947,566

(22) Filed: Apr. 6, 2018

(51) Int. Cl. G06Q 20/40; G06F 21/64; H04L 9/32; G06F 17/30

(52) U.S. Cl. CPC G06Q 20/401; G06F 17/30283; H04L 9/3213; G06F 21/645

(57) ABSTRACT

Decentralized computing and blockchain technologies have brought digital assets to the world, as well as new methods of creating traditional financial assets. The present innovation is a method for creating tradable assets on a computer implemented financial derivative that uses automated programs (smart contracts) on decentralized networks to adjust value based on an underlying reference rate. The basics of the method include two parties depositing a digital asset (similar or different) into a smart contract with details of the contract (duration, reference rate and overarching notional) agreed upon. ‘Tokens’ or shares which represent a specific side of the contract (long or short the underlying reference rate) are then created. The payout or settlement of the contract is not to a specific party but rather to the owners of the individual tokens.

This invention creates tradable tokens or digital assets that represent a share of digital assets which will be distributed at the culmination of a financial contract.

### FIELD OF THE INVENTION

The present invention relates to the novel risk management technology of creating tradable tokens for hedging underlying asset risk on decentralized computing networks. More particularly the invention allows for the trading of a position in a financial swap, forward or future contract on an underlying reference rate, with execution of the trade and contract performed on a distributed computing or distributed ledger platform with ownership of the contract represented in the form of a digital token.

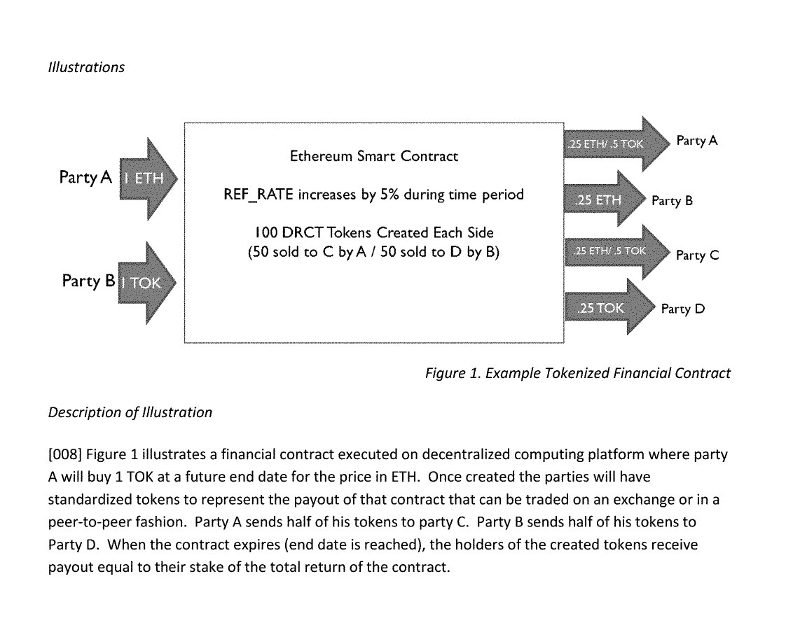

The return of [008] (FIG. 1) is specified by the formula:

Whereas: DA(i)=Digital Asset i
TokRate=DA1 value/DA2 value
N_tokens=number of tokens per side
Tok(i)Notional=notional amount of token i in contract

### Return by Digital Asset

$$Total\_payout ( DA 2 ) = Δ RefRate * Multiplier * Δ TokRate * Tok 2 Notional$$

$$Total\_payout ( DA 1 ) = \frac{- Δ RefRate * Multiplier * Tok 1 Notional}{Δ TokRate}$$

### Digital Asset 2 Receiver (Long) Payout

$$Amount Digital Asset 2 \text{:} min ( \frac{Total\_payout 2}{{ }^{n} tokens} , \frac{Tok 2 notional}{{ }^{n} tokens} )$$

$$Amount Digital Asset 1 \text{:} if Total\_payout 2 > Tok 2 Notional \text{:}$$

$$min ( \frac{Tok 1 Notional}{{ }^{n} tokens} , \frac{( \frac{Total\_payout 2 - Tok 2 Notional}{Tok 2 Notional} ) * Tok 1 Notional}{{ }^{n} tokens} )$$

### Digital Asset 1 Receiver (Short) Payout

$$Amount Digital Asset 1 \text{:} min ( \frac{Total\_payout 1}{{ }^{n} tokens} , \frac{Tok 1 Notional}{{ }^{n} tokens} )$$

$$Amount Digital Asset 2 \text{:} if {Total}_{payout 1} > Tok 1 Notional \text{:}$$

$$min ( \frac{Tok 2 Deposit}{{ }^{n} tokens} , \frac{( \frac{{Total}_{payout 1} - Tok 1 Notional}{Tok 1 Notional} ) * Tok 2 Notional}{{ }^{n} tokens} )$$

$$min ( \frac{Tok 2 Deposit}{{ }^{n} tokens} , \frac{( \frac{{Total}_{payout 1} - Tok 1 Deposit}{Tok 1 Notional} ) * Tok 2 Notional}{{ }^{n} tokens} )$$

### BACKGROUND OF THE INVENTION

Blockchain technology brought decentralized assets to the world. Decentralized computing will not only create new assets, but also new methods of creating traditional financial assets. The ability to transfer, store, and trade computationally validated contracts anonymously and over completely distributed systems will fundamentally transform the way market participants transact and thus manage risk. Similar to how the internet allowed businesses to sell to anyone in the world, distributed virtual machines will allow anyone to create and trade derivative contracts without a central clearinghouse or exchange. Cryptocurrencies and blockchains began from a paper in 2008 titled Bitcoin: A Peer-to-Peer Electronic Cash System.¹ This paper outlined the usage of a peer-to-peer network for generating the trust necessary for anonymous electronic transactions. In January 2009, the bitcoin network came into existence. Many other decentralized, distributed consensus networks have come into existence since and are creating new utility and functionality on top of the base layer of a cryptographically secured, distributed and validated database or virtual machine. ¹http://bitcoin.org/bitcoin.pdf

In traditional over-the-counter (OTC) financial derivatives, finding liquidity for bespoke or custom products can be time consuming and very expensive. The few parties (dealers) who control the majority of the market share often charge exorbitant spreads and overhead costs to enter into these financial transactions. This method increases liquidity by placing the duties of the dealer on the actions of an unlimited number of users and participants decentralized network.

Decentralized and centralized (custodial) exchange and trade protocols are developed on decentralized computing platforms. The ability to trade digital assets (‘tokens’) in a trustless and often automated manner crates a method for trading all digital assets. By creating tokens representing stakes to financial contracts, any previously bilateral agreement can now be divided into stakes on the contract and distributed as tokens.

What is claimed:

1. A computer-implemented method comprising:
shares or digital asset representations of a financial contract (smart contract or automated computer program) for executing a predetermined financial agreement to adjust value of preset margin values to the value of an underlying index and an overarching notional
with collateral and data stored on distributed consensus network for predetermined duration
means for rebalancing the margin value at end of duration and distributing at least one of the index present value to owner(s) of the owner of the tokens specified in the derivative agreement
wherein ownership or details of specified counterparties or any token holders in [022] is either known or unknown
wherein [018] has any optionality
Margin predetermined in claim [018] can be subject to or exempt from margin calls with predetermined statement of direction for collection past initial specified margin values
The underlying digital asset is not specified and can be any cryptocurrency, digital asset, virtual currency, commodity, or accepted asset.
As used herein, the term ‘decentralized consensus network’ refers to any private or public blockchain or non-blockchain based network that secures the validity of transactions using a non-specific consensus mechanism (e.g. proof-of-work, proof-of-stake, collateral-based voting, or hybrid POS system).
Certain embodiments of the present contracts underlying the present method include, but are not limited to: forward rate agreements, commodity swaps, trade options, volumetric options, swaptions, futures, options, forwards.
Wherein the process of creating the tokens specified in [018] is either optional, automated or built in to the contract
The invention discussed includes specific contracts in which margin or collateral is a different smart contract or token representing a future payout.
The present invention covers all underlying reference rates to include but not limited to: cryptocurrencies, interest rates, financial indices, equity prices, any pre-specified oracle
Margin values do not have to be equivalent on long/short sides of the contract
